(19) United States
(12) Patent Application Publication
(10) Pub. No.: US 2026/0281970 A1
(43) Pub. Date: Sep. 17, 2026

(54) METHODS AND APPARATUS FOR RANGING OF A CLIENT WIRELESSTRANSMIT/RECEIVE UNIT (WTRU) WITH AUTHORIZATION OF SIDELINK POSITIONING

(71) Applicant: InterDigital Patent Holdings, Inc., Wilmington, DE (US)

(72) Inventors: Jung Je Son, Warrington, PA (US); Anuj Sethi, Ottawa (CA); Taimoor Abbas, Sainte-Julie (CA); Alec Brusilovsky, Downingtown, PA (US)

(21) Appl. No.: 19/472,173

(22) PCT Filed: Apr. 5, 2024
(86) PCT No.: PCT/US2024/023359

§ 371 Date: Oct. 3, 2025

Related U.S. Application Data
(60) Provisional application No. 63/457,669, filed on Apr. 6, 2023.

(51) Int. Cl. H04W 64/00; G01S 5/00; H04W 76/14

(52) U.S. Cl. CPC H04W 64/006; G01S 5/01; H04W 76/14

(57) ABSTRACT

The disclosure generally pertains to procedures, methods, architectures, apparatus, systems, devices, and/or computer program products for, and/or directed to, ranging of a client Wireless Transmit Unit (WTRU) with authorization of Sidelink (SL) positioning.

### CROSS-REFERENCE TO RELATED APPLICATIONS

This application claims the benefit of U.S. Provisional Patent Application No. 63/457,669 filed Apr. 6, 2023, which is incorporated herein by reference in its entirety.

### FIELD

Example embodiments described herein generally relate to procedures, methods, architectures, apparatus, systems, devices, and/or computer program products for, and/or directed to ranging of a client Wireless Transmit Unit (WTRU) with authorization of Sidelink (SL) positioning.

### SUMMARY

In an example embodiment, a first WTRU may receive a Solicitation Request including indication of SL positioning service and info of the first WTRU and a second WTRU. The Solicitation Request may include a request for checking proximity between the first and second WTRUs. The first WTRU may transmit a response to the Solicitation Request including an indication of whether the second WTRU is in proximity of the first WTRU. For example, if the second WTRU is in proximity of the first WTRU, a PC5 connection may be established with a SL positioning client WTRU that issued the Solicitation Request. The (e.g., first) WTRU may receive, from the SL positioning client WTRU, an SL positioning service request for ranging including user info of the first and second WTRUs, and the SL positioning client WTRU. An Authorization Check may be performed with an SL Positioning Server WTRU or LMF to determine if the SL Positioning WTRU is authorized to receive positioning information about the first and second WTRUs. For example, if the SL Positioning Client WTRU is authorized to receive positioning information of the first and second WTRUs, a ranging operation may be performed with the second WTRU and a SL positioning response message may be transmitted to the SL positioning client WTRU with ranging operation results. For example, if the SL Positioning Client WTRU is not authorized to receive positioning information of the first and second WTRUs, an SL positioning response message may be transmitted to the SL positioning client WTRU with information indicating a rejection (e.g., of receiving the positioning information).

An example embodiment may include a method that includes a first WTRU receiving first information indicating a request to check proximity between the first WTRU and a second WTRU. In one example, the first information may include an indication of a sidelink (SL) positioning service and information associated with any of the first WTRU and/or the second WTRU. The method may also include transmitting second information comprising an indication of whether the second WTRU is in proximity of the first WTRU. On condition that the second WTRU is in proximity of the first WTRU, the method may include receiving, from a third WTRU (e.g., a SL positioning client WTRU), third information indicating a SL positioning service request for ranging. For example, the third information may include information associated with any of the first WTRU, the second WTRU, and/or the third WTRU. In one example, the method may include performing an authorization check to determine whether the third WTRU is authorized to receive positioning information associated with the first and second WTRUs. On condition that the third WTRU is authorized to receive the positioning information associated with the first and second WTRUs, the method may include performing a ranging operation with the second WTRU and transmitting a SL positioning response message, to the third WTRU, indicating results of the ranging operation. However, on condition that the third WTRU is not authorized to receive the positioning information of the first and second WTRUs, the method may include transmitting a reject response message to the third WTRU.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram of a reference model of a 5G/NextGen network;

FIG. 3 is a block diagram showing a reference model of a 5G/NextGen network for location service;

FIG. 4 is a diagram illustrating the positioning CP/UP architecture in NR;

FIG. 5 is a signal flow diagram illustrating signal flow for SL positioning by a client WTRU with Target WTRU discovery in accordance with some example embodiments;

FIG. 6 is a signal flow diagram illustrating signal flow for SL positioning by a client WTRU with authorization of the SL positioning client during discovery in accordance with some example embodiments;

FIG. 7 is a signal flow diagram illustrating signal flow for SL positioning with authorization of the SL positioning client WTRU during PC5 setup in accordance with some example embodiments;

FIG. 8 is a signal flow diagram illustrating signal flow for ranging with authorization of the SL positioning client WTRU in accordance with some example embodiments;

FIG. 9 is a flow chart illustrating an example process for ranging with authorization of the SL positioning client WTRU in accordance with some example embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

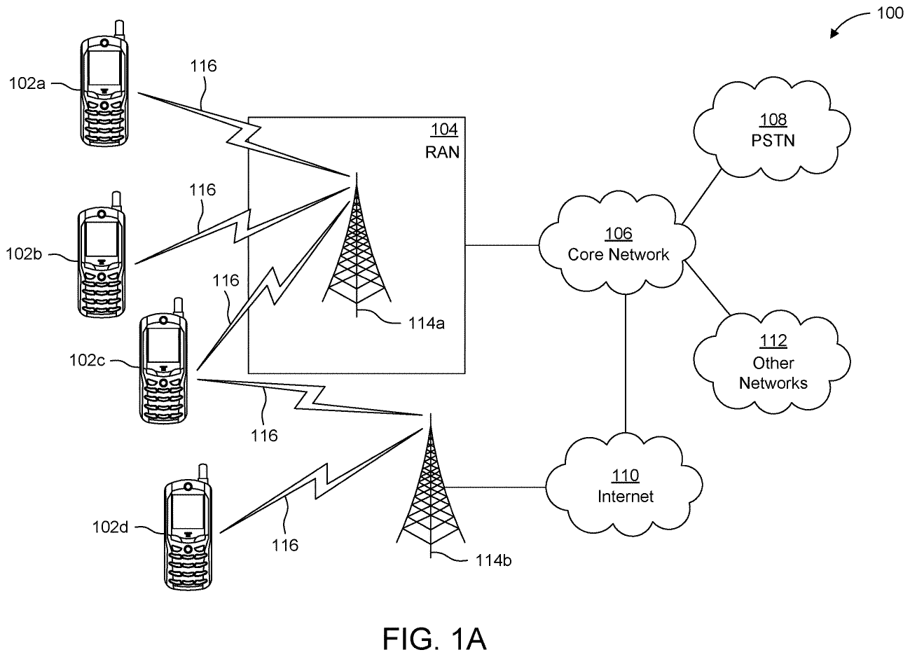

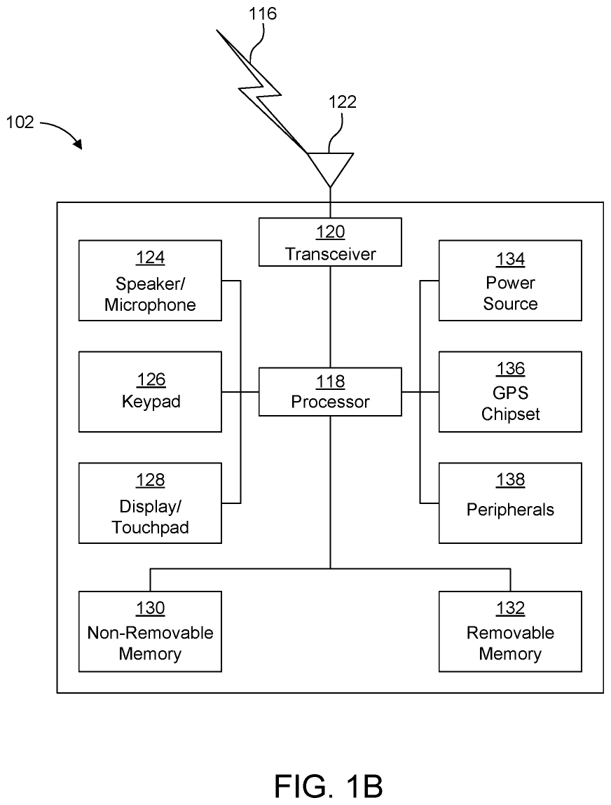

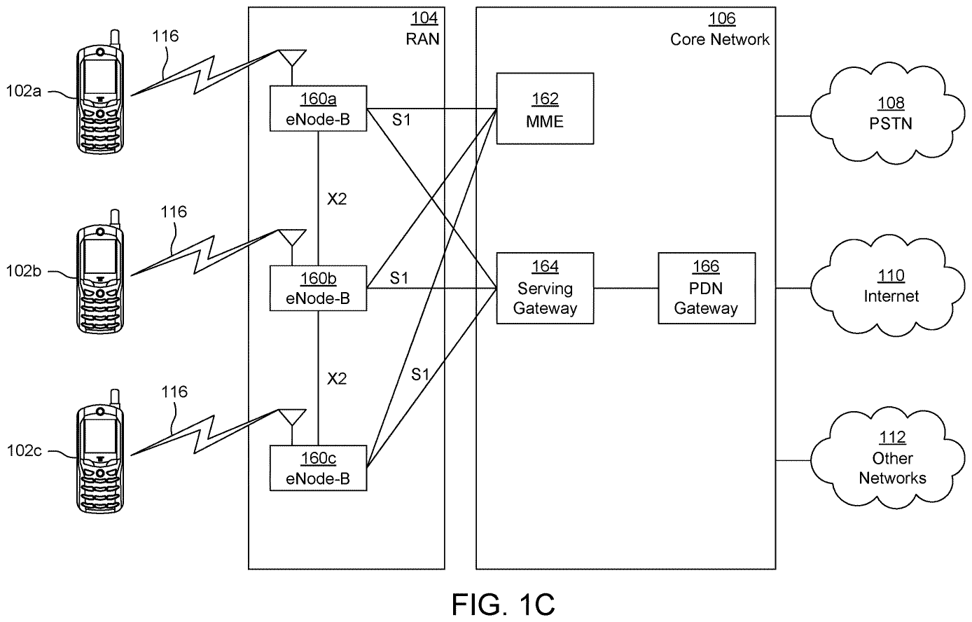

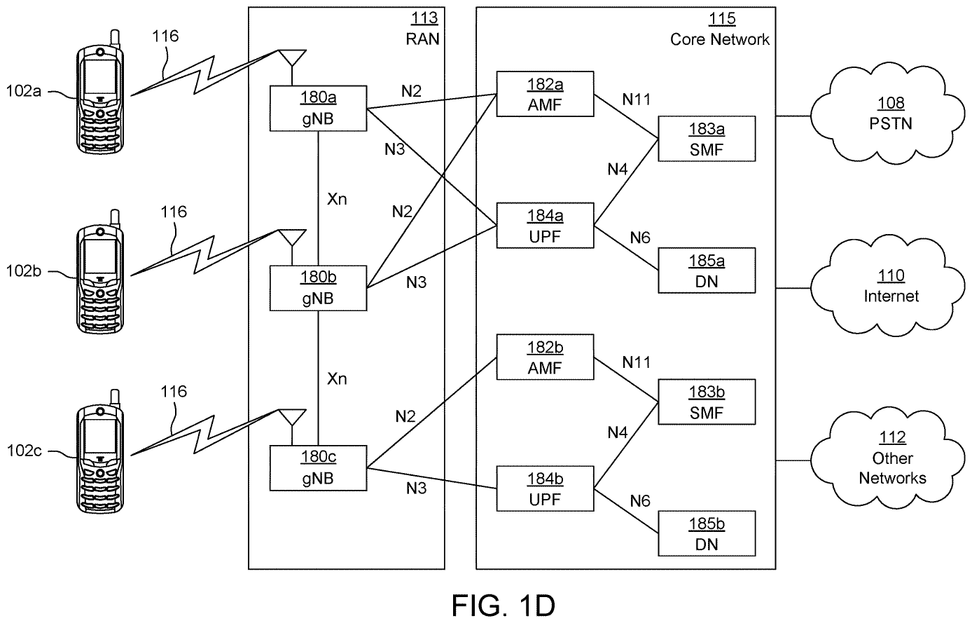

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

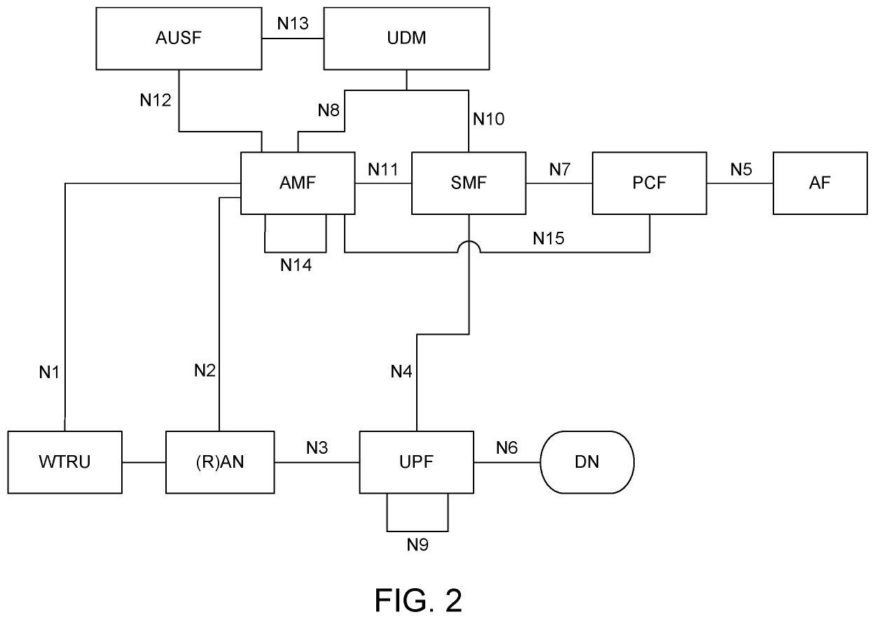

FIG. 2 is a reference model of a potential architecture of a 5G or NextGen network.

RAN here refers to a radio access network based on the 5G Radio Access Technology (RAT) or Evolved E-UTRA that connects to the NextGen core network.

The Access Control and Mobility Management Function (AMF) includes the following functionalities, registration management, connection management, reachability management, mobility Management, etc.

The Session Management Function (SMF) includes the following functionalities, session management (including session establishment, modification and release), WTRU IP address allocation, selection and control of User Plane (UP) function, etc.

The User Plane Function (UPF) includes the following functionalities, packet routing & forwarding, packet inspection, traffic usage reporting, etc.

5G location service (LCS) offers the functionality to provide positioning information of a WTRU.

The positioning of a WTRU can be supported by RAT-dependent position methods, which rely on, for example, 3GPP RAT measurements obtained by a target WTRU and/or on measurements obtained by an Access Network of 3GPP RAT signals transmitted by a target WTRU. Positioning of a WTRU can also be supported by RAT-independent position methods, which may rely on non-RAT measurements obtained by a WTRU and/or on other information.

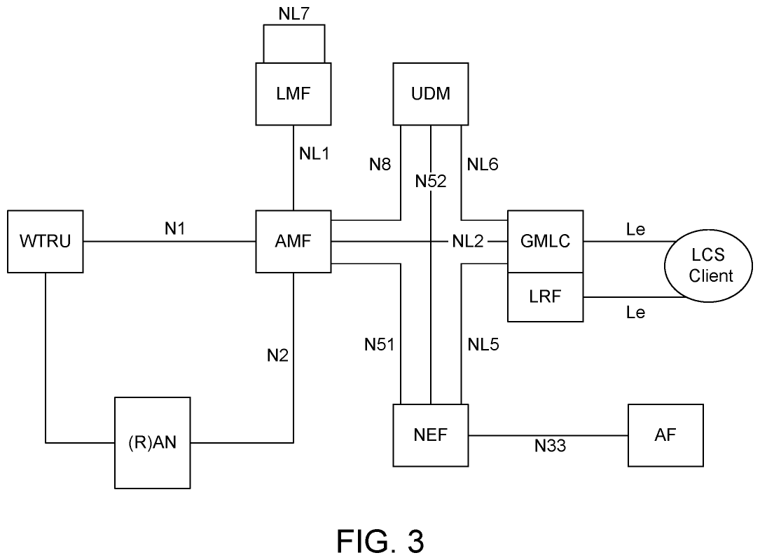

With reference to FIG. 3, which is a block diagram showing a reference model of a 5G/NextGen network for location service, location information for one or multiple target WTRUs may be requested by and reported to an LCS client or an Application Function (AF) within or external to a 3GPP operator network, or a control plane Network Function (NF) within a 3GPP system.

For a location request from an LCS client or an AF, privacy verification of the target WTRU shall be enabled to check whether it is allowed to acquire the WTRU location information.

5G supports several different types of location requests, including: (1) Mobile Terminated Location Request (MT-LR), wherein an LCS client or AF sends a location request to the 5G Network for the location of a target WTRU; (2) Mobile Originated Location Request (MO-LR), wherein a WTRU sends a request to the 5G Network for location related information for the WTRU; (3) Immediate Location Request, wherein an LCS client or AF sends or instigates a location request for a target WTRU(s) and expects to receive a response containing location information for the target WTRU(s) within a short time period (may be used for an MT-LR or MO-LR); and (4) Deferred Location Request, wherein an LCS client or AF sends a location request to the 5G network for a target WTRU(s) and expects to receive a response when an indicated event occurred for the target WTRU at some future time (may be used for an MT-LR).

(R)AN here represents NG-RAN, trusted non-3GPP access, or untrusted non-3GPP access. The access network is involved in the handling of various positioning procedures including positioning of a target WTRU, provisioning of location related information not associated with a particular target WTRU and transferring of positioning messages between an AMF or (Location Management Function) LMF and a target WTRU.

AFs and NFs may access LCS services from a GMLC (Gateway Mobile Location Center) in the same 3GPP operator network.

LCS clients may access LCS services from a GMLC and External AFs may access LCS service from a Network Exposure Function (NEF).

The GMLC (Gateway Mobile Location Centre) handles the requests from external LCS clients and AFs via an NEF if the AF is an external AF, and forwards location requests to the proper NF.

The LRF (Location Retrieval Function) is responsible for retrieving or validating location information and may be co-located with a GMLC or may be separately located.

The LMF (Location Management Function) manages the overall co-ordination and scheduling of resources required for the location of a WTRU that is registered with or accessing a 5G Core Network (CN). It may calculate or verify final location related information and achieved accuracy.

Positioning protocols and RAN-based positioning signals have been specified in 3GPP since Release 9 LTE for enabling emergency services and location-based services.

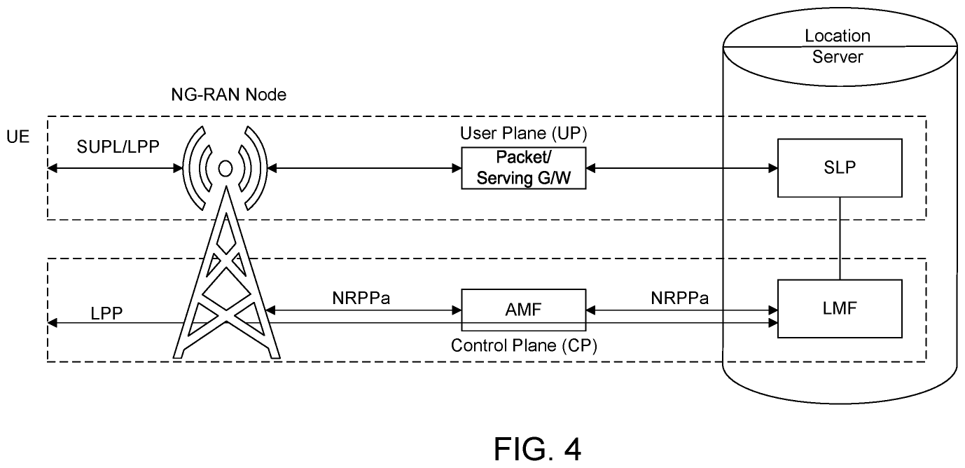

In Rel-17, 3GPP NR positioning protocols are supported by the Control Plane (CP) positioning architecture over the Uu interface (NG-RAN node to WTRU). The NR positioning architecture may also be supported by a Secure User Plane Location (SUPL) server, also known as a SUPL Location platform (SLP) or location server, that may leverage any IP bearer. Interworking for CP and UP positioning solutions are defined in TS 38.305, where SUPL can also be used as a tunnel for CP positioning protocols (e.g., LPP) [4]. This is shown in the FIG. 4, which illustrates the NR positioning CP/UP architecture.

3GPP has defined various protocols to enable several positioning technologies and methods (GNSS (Global Navigation Satellite System), sensors, positioning signals, etc.). The primary protocol, LPP (LTE Positioning protocol), is terminated between the WTRU and the LMF (Location Management Function). LPP is a Point-to-Point LCS and NAS (Non-Access Stratum) messaging protocol that is defined in TS 37.355. LPP has been agreed to be re-used for NR since Rel-15 and will continue to be leveraged for the foreseeable future.

RRC (Radio Resource Control) is another protocol used to provide transport for LPP messages and other positioning procedures over the NR-Uu interface, which is terminated between the gNB and the WTRU.

On the network side, NGAP (NG Application Protocol) is terminated between the AMF and the NG-RAN Node(s) (i.e., gNB/TRP) and is used as a transport for LPP and NRPPa messages over the NG-C (Next Generation Core Network) interface.

Finally, NRPPa (NR Positioning Protocol A) carries information between the NG-RAN Node(s) and the LMF.

Positioning can be performed in: Standalone, WTRU-Based, or WTRU-Assisted modes.

In Standalone positioning, the WTRU handles all aspects of the positioning, scans for accessible sources of positioning, measures, and processes positioning signals/sources. Finally, the WTRU computes its own position in 2 or 3 dimensions. In Standalone positioning, the Uu interface impacts include WTRU capability exchange and reporting of the WTRU position.

In WTRU-Based Positioning (WTRU-B), the network provides acquisition assistance data, and the WTRU scans for accessible sources of positioning, measures, and processes positioning signals/sources (based on assistance information from the network). Finally, the WTRU computes its own position in 2 or 3 dimensions and may report its position to the network.

In WTRU-Assisted Positioning (WTRU-A), the network provides acquisition assistance, and the WTRU scans for accessible sources of positioning, and measures positioning signals/sources (based on assistance information from the network). Finally, the WTRU returns measurements to the network, and the network computes the device position (at the location server/LMF).

Table 1 below shows the supported techniques of WTRU positioning methods (defined in TS38.305)

TABLE 1

| | | UE-assisted, LMF- |
|---|---|---|
| Method | UE-based | based |
| DL-TDOA | Yes | Yes |
| DL-AoD | Yes | Yes |
| Multi-RTT | No | Yes |
| NR E-CID | No | Yes |
| UL-TDOA | No | No |
| UL-AoA | No | No |

The LTE positioning protocol (LPP) messages related to WTRU-assisted location request(s) include the following procedures:
Request Capabilities; LMF request to the WTRU
Provide Capabilities; WTRU response to the LMF
Request Assistance Data; WTRU request to the LMF for positioning assistance data/information
Provide Assistance Data; LMF to WTRU positioning assistance data information/configuration (additionally, broadcast of positioning Assistance Data (AD) is supported via Positioning System Information Blocks (posSIBs) and carried in SI messages [3][4])
Request Location Information; LMF request to the WTRU for position/measurements
Provide Location Information; WTRU to LMF, position and/or measurements
Abort; Abort LPP session
Error; Errors associated with positioning procedure(s)

SL positioning (or SL based positioning service) is defined as positioning of a WTRU using PC5 to obtain absolute position, relative position, or ranging information. Ranging refers to the determination of the distance between two or more WTRUs and/or the direction of one WTRU (i.e. Target WTRU) from another WTRU (i.e. Reference WTRU) via PC5 interface.

For SL positioning, the following terms may be defined and used as follows.

A Target WTRU is a WTRU whose distance, direction, and/or position is measured with the support from one or multiple SL Reference WTRUs using Sidelink in the ranging based service and Sidelink positioning.

A Located WTRU is a SL Reference WTRU of which the location is known or is able to be known using Uu based positioning. A Located WTRU can be used to determine the location of a Target WTRU using Sidelink Positioning.

A SL Reference WTRU is a WTRU that supports the positioning of a target WTRU, e.g., by transmitting and/or receiving reference signals for positioning, providing positioning-related information, etc. using Sidelink.

A SL Positioning Client WTRU is a third-party WTRU, other than a SL Reference WTRU and Target WTRU that initiates a Ranging/Sidelink positioning service request on behalf of an application residing on it.

The operation of Ranging/Sidelink Positioning can be performed with either Network-assisted Operation or WTRU-only Operation.

In Network-assisted operation, 5GC NF(s) are involved for the service request handling and result calculation.

In WTRU-only operation, the service request handling and result calculation are performed by the WTRU.

When Network-assisted operation is used, the LMF defined in the 5G Location Service may be used to support triggering SL positioning, coordinating SL positioning operation, and delivering the result to the client. The Ranging/Sidelink Positioning service request can be initiated by a WTRU (i.e. SL Positioning Client WTRU, Target WTRU, SL Reference WTRU), a 5GC NF, an LCS Client or an AF.

When WTRU-only operation is used, WTRUs interact with each other over PC5 as necessary in order to perform SL positioning operations. An SL positioning server WTRU is defined to coordinate SL positioning operation and calculate the positioning result.

A SL Positioning Server WTRU is a WTRU offering method determination, assistant data distribution, and/or location calculation functionalities and/or location calculation functionalities for Sidelink Positioning and Ranging based service.

Network Assisted SL positioning is used to estimate the location of a WTRU with the assistance of the network by using the location of one or more Located WTRUs and the distance and/or direction between the WTRU and the Located WTRU(s).

The Network assisted SL Positioning feature has two cases, namely, when the WTRU can establish a NAS signaling connection and when the WTRU cannot establish a NAS signaling connection.

When a WTRU can establish a NAS connection, the WTRU enters Connection Management (CM)-Connected state by performing a WTRU triggered Service Request for 5GC-MO-LR or performing Network triggered Service Request for 5GC-NI (Network Induced)-LR or 5GC-MT-LR. As the Target WTRU can establish a NAS signaling connection with the AMF, the functionality specified in 5G Location Service can be reused including e.g. 5GC-MO-LR, 5GC-MT-LR and 5GC-NI-LR.

Either the Target WTRU or LMF determines if network assisted SL positioning will be applied.

The Target WTRU discovers Located WTRU(s) for network assisted SL positioning.

The Target WTRU and Located WTRU(s) perform ranging/SL positioning. The Target WTRU includes the WTRU identity of the Located WTRU(s) to the LMF together with the Ranging measurement data or estimation result. The LMF may interact with the GMLC to get the location of Located WTRU.

The LMF uses the location of Located WTRU(s) together with the ranging/SL positioning measurement data or estimation results reported by the Target WTRU and optionally also by Located WTRUs to estimate the location of the Target WTRU.

When the Target WTRU cannot establish the NAS connection with the AMF due to the Target WTRU being out of coverage, for 5GC-MO-LR or pending 5GC-MT-LR (e.g. deferred 5GC-MT-LR), the following principles are applied.

The Target WTRU performs the Located WTRU's discovery and selection.

The Target WTRU may transmit its ranging measurements/results to the Located WTRU(s).

Located WTRU(s) may report the ranging/SL positioning measurement result to the LMF. This may include ranging measurements/results received from the Target WTRU. The endpoints for LPP messages are the LMF and the Located WTRU(s).

The LMF may use the received information to calculate the location of the Target WTRU and provide the resulting location via the Located WTRU to the Target WTRU or via 5G NF to the LCS client or the Application Server.

A WTRU (so called SL positioning client WTRU) may request SL positioning through PC5 or through the network.

When a SL positioning client WTRU requests SL positioning service through PC5 connection, it can discover one of the Reference WTRU and the Target WTRU, and it may invoke the Ranging/SL Positioning service request to the discovered Reference WTRU/Target WTRU for obtaining the Ranging and SL positioning result between the Reference WTRU and the Target WTRU. This request includes the user info of SL Positioning Client WTRU, Reference WTRU and Target WTRU.

For SL positioning service exposure to the WTRU, when SL Positioning Client WTRU invokes SL positioning service to Reference WTRU that is discovered by sending a Ranging/SL positioning service request, there are at least three operational matters to consider. First, methods and apparatus are desired for the SL positioning client WTRU to acquire the SL reference WTRU's information in proximity of target WTRU.

Particularly, when the SL positioning client WTRU invokes the Ranging/SL positioning service request, it should include the user info of the SL Positioning Client WTRU, Reference WTRU, and Target WTRU. However, based on deployment and positioning of each WTRU, the SL positioning client WTRU may directly discover only the target WTRU or SL reference WTRU. In this case, the SL positioning client WTRU cannot acquire information of a WTRU that is not discoverable directly and the SL positioning client WTRU cannot ensure whether there is any SL reference WTRU available for SL positioning operation with target WTRU.

Here the issue is how can the SL positioning client WTRU acquire the SL reference WTRU's information in proximity of a target WTRU.

Second, methods and apparatus are desired for the SL positioning client WTRU to be authorized for SL positioning of the target WTRU.

Particularly, the location information of the target WTRU is personal and sensitive information. In 5GC LCS service, an LCS client can be checked for whether it is authorized to acquired location information of the target WTRU by referring subscription data of the target WTRU in Unified Data Management (UDM). It should be possible to check whether or not the SL positioning client WTRU is authorized on the network to acquire location information of the target WTRU.

Further, the target WTRU should be able to check the user info of the SL positioning client WTRU in order to evaluate whether the SL positioning client WTRU is authorized or not.

Here, the issue is how can the SL positioning client WTRU be authorized for SL positioning of the target WTRU.

Third, for ranging operation, methods and apparatus are desired for the SL positioning client WTRU to ensure that ranging service is available when one WTRU is discoverable by the client WTRU.

Particularly, the SL positioning client WTRU may request ranging service between two WTRUs (WTRU1 and WTRU2). If the client WTRU can discover both WTRU1 and WTRU2directly, it may check if ranging service is possible between WTRU1 and WTRU2. But, if only one WTRU (i.e., WTRU1 or WTRU2) can be discovered directly by the client WTRU, the client WTRU cannot ensure that the other WTRU is in the proximity of the discovered WTRU so that ranging service is possible.

Here, the issue is how can the SL positioning client WTRU determine whether the expected ranging service is available or not even when only one WTRU is discoverable by the client WTRU.

Example embodiments presented herein may assume that a WTRU supports PC5Signaling. This PC5 signaling may be supported by the ProSe layer in the WTRUs.

The WTRUs in certain embodiments may have capability of ranging and Sidelink positioning. Here, Sidelink positioning refers to the positioning via PC5 interface and ranging refers to the determination of the distance between two or more WTRUs and/or the direction and/or position of one WTRU relative to another WTRU.

An embodiment may include procedures for SL positioning by a client WTRU with target WTRU discovery. During a discovery procedure, when an SL positioning client WTRU discovers a Target WTRU, the Target WTRU may inform the SL positioning client WTRU of an SL reference WTRU in proximity so that the SL positioning client WTRU may invoke an SL positioning service request.

Based on the request and the client WTRU's information that may be included therewith, the Target WTRU may initiate a procedure for checking the authorization of the SL positioning client WTRU.

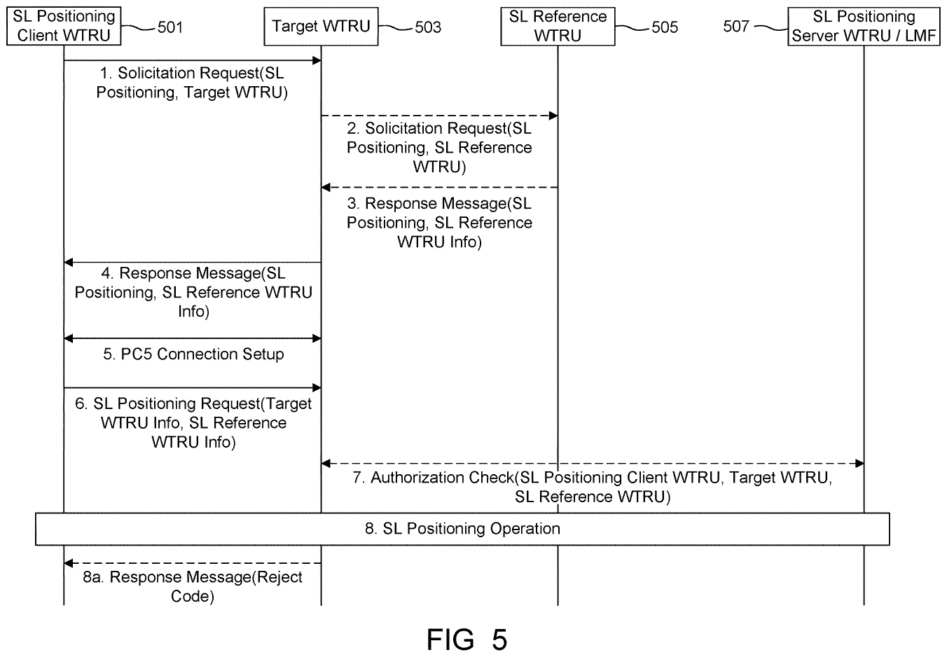

FIG. 5 is a signal flow diagram illustrating signal flow for SL positioning by a client WTRU with Target WTRU discovery.

In step 1, the SL positioning client WTRU 501 is triggered to discover the target WTRU 503 for SL positioning service and transmits a Solicitation request message, including indication of SL positioning service and info of the target WTRU.

In step 2, when the target WTRU 503 receives the solicitation request message from the client WTRU, it may try to discover any SL reference WTRU(s) within proximity for the SL positioning service by sending solicitation request message.

In step 3, any SL reference WTRU(s) within proximity to receive the message, such as SL Reference WTRU 505, may respond to the solicitation message from target WTRU.

In step 4, when the target WTRU 503 responds to the client WTRU 501, it may include information of the discovered SL reference WTRU(s). If multiple SL reference WTRU(s) responded in step 3, then the target WTRU may include multiple SL reference WTRUs information. Alternately, only one or the several SL reference WTRUs may be selected for reporting back to the client WTRU 501 based on some condition, such as link quality.

Alternatively, when the target WTRU 503 already has information about the SL reference WTRU(s) being in proximity (at least there are already a sufficient number of discovered reference WTRU by the target WTRU), it may include the information in the response message to the client WTRU without performing step 2 and step 3.

In step 5, the Client WTRU 501 may setup a PC5 connection with the target WTRU 503 after a successful discovery procedure.

Alternatively or additionally, the target WTRU 503 may provide information of the SL reference WTRU(s) to the Client WTRU 501 during a PC5 connection setup or after PC5connection setup, for example, as embedded in the PC5 connection setup signaling message or by using a separate signaling message.

In step 6, the Client WTRU 501 may invoke an SL positioning service request including the target WTRU info and SL reference WTRU(s) info that was received from the target WTRU 503.

In step 7, after the SL positioning service request is received, the target WTRU 503 may communicate with the SL positioning server WTRU or 5GC 507 to evaluate whether the SL positioning client WTRU is authorized to receive the positioning information of the target WTRU 503. The Target WTRU 503 may include a list of SL reference WTRUs in the service request for authorization to the SL positioning server WTRU or 5GC 507.

Alternately, the Target WTRU 503 may be configured with the list of client WTRUs information that are authorized for positioning information of target WTRU, in which case, step 7 may be omitted.

If the SL positioning client WTRU 501 is authorized to receive positioning information of the Target WTRU 503, then, in step 8, the Target WTRU 503 and SL reference WTRU(s) 505 may perform SL positioning operation as requested by the SL positioning client WTRU 501. If, on the other hand, authorization fails (e.g., in step 7), then, instead, the Target WTRU 503 may reject the SL Positioning Request received in step 6 (step 8a). If the Target WTRU 503 responds with a rejection, it may include a reject code indicating the reason for the rejection, for example, authorization failure.

In step 8, during SL positioning operation, if more SL reference WTRU(s) need to be discovered, the target WTRU may perform more rounds of discovery phases and reporting (i.e., steps 2 through 3).

In step 8, the information of service request including information of SL reference WTRUs may be reported to the SL positioning server WTRU or LMF for coordination of SL positioning operations.

Additionally or alternately, the SL positioning service request may be also delivered to SL reference WTRU(s) 505 in step 6 by the client WTRU 501 or by the target WTRU 503, and, if needed, the target WTRU 503 and SL reference WTRU(s) 505 may establish PC5 connection(s) with each other.

Alternately, after receiving the solicitation request message in step 1, the Target WTRU 503 may communicate with the SL positioning server WTRU or 5GC 507 to evaluate whether the SL positioning client WTRU is authorized to receive the positioning information of the target WTRU 503. If the authorization of the client WTRU 501 fails, the Target WTRU 503 may, instead, reject the Solicitation message received in step 1. If the target WTRU 503 rejects the solicitation message, it may include a reject code in the response indicating the reason for the rejection, for example, authorization failure.

Alternately, before step 2, the Target WTRU 503 may receive or be configured with (from or by the SL Positioning Server WTRU or LMF 507a) a list of candidate SL reference WTRU(s). The target WTRU 503 may select one or more SL Reference WTRU(s) that are discovered and belong to the candidate list of SL reference WTRU(s) for SL positioning operation and include information of those selected WTRU(s) in the response message in step 4.

An embodiment may include procedures for SL positioning with authorization of SL positioning client WTRU during discovery. In this embodiment, the SL positioning client may try to discover the target WTRU or the SL reference WTRU(s) in proximity of the target WTRU for SL positioning service. The SL positioning client WTRU may indicate that the SL reference WTRU(s) need to be discovered in proximity of the target WTRU in the solicitation message so that the proper SL reference WTRU(s) can join the discovery procedure.

When receiving the solicitation request message from the client WTRU, the SL reference WTRU(s) may try to discover the target WTRU. In the discovery procedure between the SL reference WTRU and the target WTRU, the SL reference WTRU may indicate that it is for SL positioning service of the SL positioning client WTRU by including information of the SL positioning client WTRU.

The Target WTRU may evaluate whether the SL positioning client WTRU is authorized for the positioning information of the target WTRU and, after successful authorization, the Target WTRU may respond to the SL reference WTRU.

After successful discovery procedure of SL reference WTRU(s) in proximity of the target WTRU, the client WTRU may setup a PC5 connection with the SL reference WTRU and invoke an SL positioning service request to the discovered SL reference WTRU.

After receiving an SL positioning service request, the SL reference WTRU may check whether the client WTRU is authorized to receive the positioning information of the target WTRU, and, if so, perform an SL positioning operation with the target WTRU.

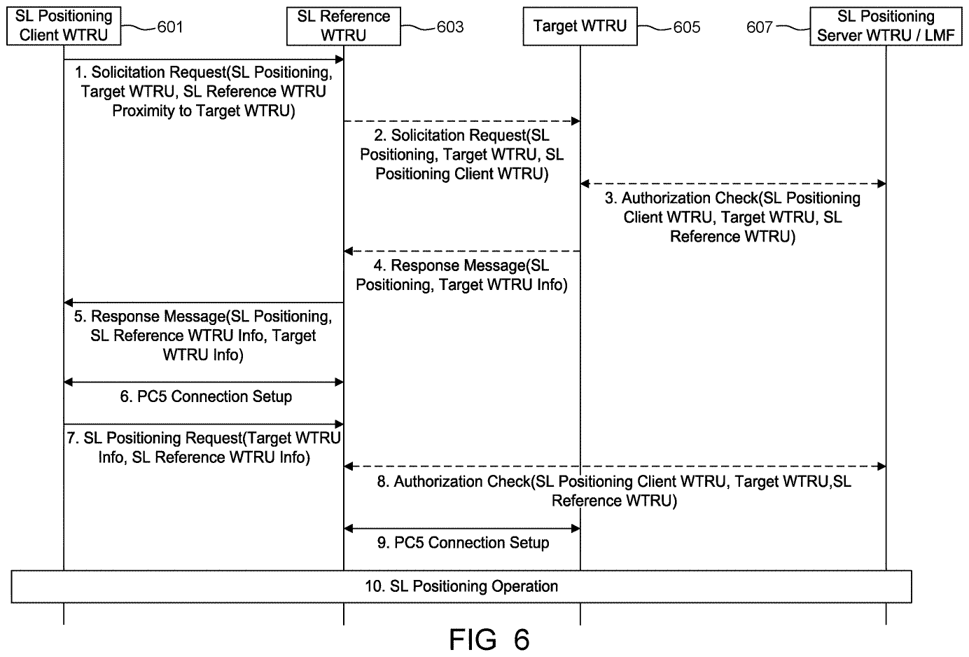

FIG. 6 is a signal flow diagram illustrating signal flow for SL positioning by a client WTRU with authorization of the SL positioning client during discovery in accordance with this embodiment.

In step 1, the SL positioning client WTRU 601 is triggered to discover the target WTRU 603 for SL positioning service and transmits a Solicitation request message, including indication of SL positioning service and information of the Target WTRU 605, e.g., user information of the Target WTRU. The client WTRU 601 may include indication that SL reference WTRUs 603 in proximity to the target WTRU 605 may respond.

When an SL reference WTRU 603 receives a solicitation request message from the client WTRU 601 that includes the indication that SL reference WTRUs in proximity of the target WTRU may respond, it checks whether it is in proximity of target WTRU 605. If there is no information available relating to the proximity of target WTRU 605, in step 2, it may try to discover target WTRU 605 by sending a solicitation request message including information of the target WTRU.

The SL reference WTRU 603 may include information of the SL positioning client WTRU 601 that it received in step 1.

In step 3, when the target WTRU 605 receives a solicitation request message for discovering itself, it may check whether the solicitation request message includes information of the SL positioning client WTRU 601 and, if so, then, it check whether the identified SL positioning client WTRU is authorized to request the positioning information of the target WTRU by communicating with the SL positioning server WTRU or 5GC network 607.

Alternately, the Target WTRU 607 may be configured with a list of client WTRUs information that are authorized to receive positioning information of the Target WTRU, in which case step 3 may be omitted.

In step 4, the Target WTRU 607 may respond to the solicitation request message from the SL reference WTRU (assuming it determines that the SL positioning client WTRU is authorized to receive the positioning information of the Target WTRU). If the authorization of client WTRU fails in step 3, the Target WTRU 605 may reject the Solicitation message or may just ignore the received solicitation request message in step 1 (not shown). If the Target WTRU 503 rejects the Solicitation message, it may send a Response message with reject in step 4 (not shown) and it may include a reject code indicating the reason for rejection, for example, authorization failure.

Step 2, step 3, and step 4 may be omitted if the SL reference WTRU 605 is aware that the Target WTRU 605 is in proximity and it can communicate with the target WTRU.

Alternately, even if the SL reference WTRU 603 is aware that the Target WTRU 605 is in proximity, for authorization of the SL positioning client WTRU 601, the SL reference WTRU 603 may send a solicitation request message including information of the SL positioning client WTRU 601.

In step 5, the SL reference WTRU(s) 603 respond to the solicitation request message of the client WTRU 601. It is assumed that every responding SL reference WTRU(s) is in proximity of the target WTRU 607.

If the SL Reference WTRU 603 received a Response message with a rejection in step 4, the SL Reference WTRU 603 may, instead, send a Response message with reject in step 5 to the SL positioning client WTRU 601 or just ignore the received solicitation request message in step 1 (not shown). If the SL Reference WTRU 603 responds with a reject in step 5, it may include a reject code indicating the reason for the rejection, for example, authorization failure.

When the SL Reference WTRU 603 sends a Response message with reject in step 5, the procedures fails and one or more of the steps from step 6 to step 10 may be omitted.

Alternately, the SL reference WTRU 603 may indicate that it is in proximity to the target WTRU 605 in the response message (step 5).

In step 6, the Client WTRU 601 may select a proper SL reference WTRU 603 and setup PC5 connection with the selected SL reference WTRU 603.

Alternately, after receiving the Response message in step 5 or after step 6, the SL Positioning Client WTRU 601 may request the SL Reference WTRU 603 to report whether the target WTRU 605 was discovered by the SL Reference WTRU 603. If it is requested by the SL Positioning Client WTRU 601, the SL Reference WTRU 603 may perform a discovery procedure (for example, step 2 and step 3) and may report the result of whether the target WTRU 605 was discovered to the SL Positioning Client WTRU 601.

In another alternative, during PC5 connection setup of step 6 or after PC5 connection setup, the SL Reference WTRU 603 may perform a discovery procedure (for example, step 2 and step 3) and may report whether the target WTRU 605 is in proximity of the SL Positioning Client WTRU 601.

In yet another alternative, if the Client WTRU 601 is aware that the SL Reference WTRU 603 is not in proximity to the target WTRU 605, the Client WTRU 601 may repeat the procedure from step 1 until it discover the target WTRU 605 or a SL Reference WTRU 603 in proximity to the target WTRU 605.

In step 7, the Client WTRU 601 may send a SL positioning service request to the selected SL reference WTRU 603. The SL positioning service request may include SL positioning client WTRU information, target WTRU information, and/or SL reference WTRU(s) information for SL positioning service.

In step 8, when the SL positioning service request is received, the SL reference WTRU 603 may communicate with the SL positioning server WTRU or 5GC LMF 607 to evaluate whether the SL positioning client WTRU 601 is authorized to receive the positioning information of the target WTRU 605.

Step 8 may be performed before or after step 9.

If the authorization was successful, then, in step 9, the SL reference WTRU 603 and target WTRU 605 setup a PC5 connection for SL positioning service.

On the other hand, if the authorization failed in step 8, then, instead, the SL Reference WTRU 603 sends a Respond message with reject (not shown) to the SL positioning client WTRU 601 (or may simply not respond to the received solicitation request message in step 1), and the remaining steps are omitted. If the SL Reference WTRU 603 responds with a reject, it may include a reject code indicating the reason for the rejection, for example, authorization failure.

Assuming the authorization was successful, then, in step 10, the Target WTRU 605 and SL reference WTRU(s) 603 perform SL positioning operation as requested by the SL positioning client WTRU 601.

In step 10, the target WTRU 605 and/or SL reference WTRU(s) 603 may communicate with the SL positioning server WTRU or LMF 607 for coordination of SL positioning operation.

If multiple SL reference WTRUs are included in the SL positioning service request in step 7, that fact is reported to the SL positioning server WTRU or LMF 607 for coordination of SL positioning operation.

Additionally or alternately, if multiple SL reference WTRUs are included in the SL positioning service request in step 7, the request may be delivered to each SL reference WTRU included in the request by the client WTRU 601 or the SL reference WTRU 603 selected in step 6, and, if needed, the target WTRU and SL reference WTRU(s) may establish PC5 connections.

Additionally or alternately, if multiple SL reference WTRUs are included in the service request in step 7, the SL reference WTRU 603 may forward the SL positioning service request to the target WTRU 605 and the target WTRU and SL reference WTRU(s) may establish PC5 connections.

An embodiment may include procedures for SL positioning with authorization of SL positioning client WTRU during PC5 setup. The SL positioning client may try to discover the target WTRU or SL reference WTRU(s) in proximity of the target WTRU for SL positioning service. The SL positioning client WTRU may indicate that the SL reference WTRU(s) needs to be discovered in proximity of the target WTRU in the solicitation message so that the proper SL reference WTRU(s) may join the discovery procedure.

When receiving the solicitation request message from the client WTRU, the SL reference WTRU(s) may try to discover the target WTRU.

After successfully discovering one or more SL reference WTRU(s) in proximity of the target WTRU, the client WTRU may setup a PC5 connection with the SL reference WTRU and invoke SL positioning service request to the discovered SL reference WTRU.

The SL reference WTRU may setup a PC5 connection for SL positioning service as requested by the client WTRU, and the SL reference WTRU may inform the target WTRU of the information of the client WTRU during the PC5 connection setup procedure.

The Target WTRU may check whether the client WTRU is authorized to receive the positioning information of the Target WTRU, and setup PC5 connection with SL reference WTRU for the SL positioning service.

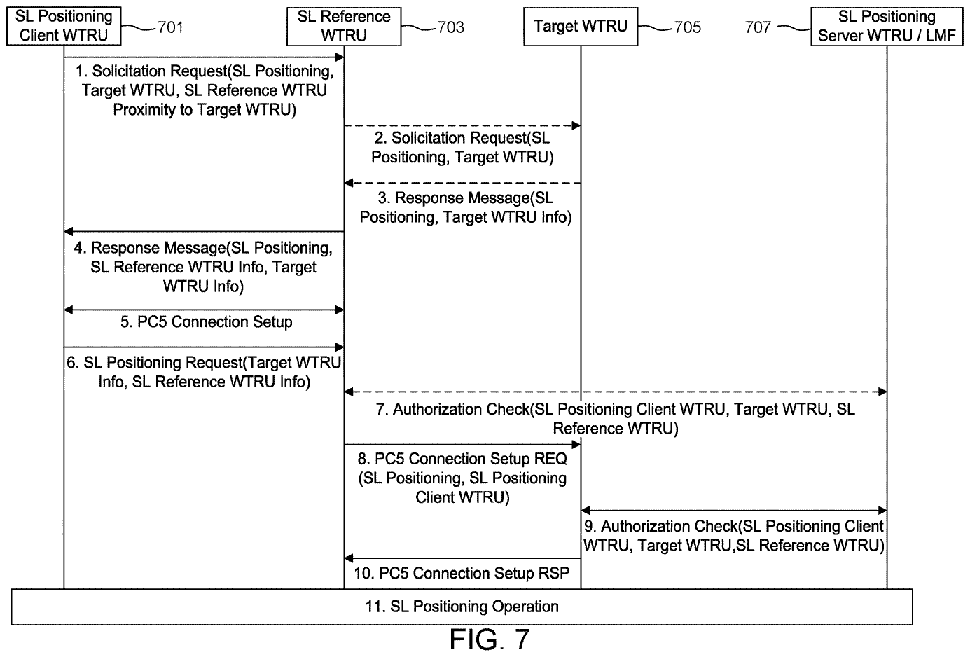

FIG. 7 is a signal flow diagram illustrating signal flow for SL positioning with authorization of the SL positioning client WTRU during PC5 setup in accordance with some example embodiments.

In step 1, the SL positioning client WTRU 701 is triggered to discover a target WTRU for SL positioning service. The client WTRU 701 sends a Solicitation request message including indication of SL positioning service and information of the target WTRU. The client WTRU 701 may include indication that an SL reference WTRU in proximity to the target WTRU may respond.

In step 2, when an SL reference WTRU 703 receives the solicitation request message from client WTRU 701 that includes the indication that SL reference WTRUs in proximity of the target WTRU 705 may respond, it checks whether it is in proximity of the target WTRU 705. If there is no information available relating to the proximity of the target WTRU, it may try to discover the target WTRU by sending a solicitation request message including information of the target WTRU.

In step 3, the Target WTRU 705 may respond to the solicitation request message from SL reference WTRU.

Step 2 and step 3 may be omitted if the SL reference WTRU 703 is aware that the target WTRU 705 is in proximity and that it can communicate with the target WTRU.

In step 4, the SL reference WTRU(s) 703 may respond to the solicitation request message from the client WTRU 701. It is assumed that every responding SL reference WTRU is in proximity of the target WTRU 705.

Alternatively, the SL reference WTRU 703 may indicate that it is in proximity to the target WTRU 705 in the response message.

In step 5, the Client WTRU 701 may select a proper SL reference WTRU and setup a PC5 connection with the selected SL reference WTRU 703.

Alternately, after receiving Response message in step 4 or after step 5, the SL Positioning Client WTRU 701 may request the SL Reference WTRU 703 to report whether the target WTRU 705 was discovered by the SL Reference WTRU 703. If it is requested by SL Positioning Client WTRU 701, the SL Reference WTRU 703 may perform a discovery procedure (for example, step 2 and step 3) with the Target WTRU 705 and may report the result of whether the target WTRU 705 was discovered to the SL Positioning Client WTRU 701.

In another alternative, during PC5 connection setup of step 5 or after PC5 connection setup, the SL Reference WTRU 703 may perform a discovery procedure (for example, step 2 and step 3) with the Target WTRU 705 and may report the result of whether the target WTRU 705 was discovered to the SL Positioning Client WTRU 701.

In yet another alternative, if the Client WTRU 701 is aware that the SL Reference WTRU 703 is not in proximity of the target WTRU 705, the Client WTRU 701 may repeat the procedure from step 1 until it discovers the target WTRU 705 or a SL Reference WTRU 703 in proximity to the target WTRU 705.

In step 6, the Client WTRU 701 may send a SL positioning service request to the selected SL reference WTRU 703. The SL positioning service request includes SL positioning client WTRU info, target WTRU info, and SL reference WTRU(s) info for SL positioning service.

In step 7, after the SL positioning service request is received, the SL reference WTRU 703 may communicate with the SL positioning server WTRU or 5GC 707 to evaluate whether the SL positioning client WTRU is authorized to receive the positioning information of the target WTRU.

If authorization of the client WTRU 701 fails in step 7, the SL Reference WTRU 703 may reject SL Positioning Request (not shown) like the ones previously described in connection with FIGS. 5 and 6 (see, e.g., alternate step 8a in FIG. 5), and the remaining steps may be omitted.

On the other hand, if authorization of the client WTRU 701 is successful, then, in step 8, the SL reference WTRU 703 and the target WTRU 705 setup a PC5 connection for SL positioning service. While setting up the PC5 connection, the SL reference WTRU 703 may inform the target WTRU 705 of information of the SL positioning client WTRU 701 so that the target WTRU 705 is aware that the client WTRU 701 is a consumer of positioning information of the target WTRU 705.

In step 9, the Target WTRU 705 may communicate with the SL positioning server WTRU or 5GC 707 to evaluate whether the SL positioning client WTRU 701 is authorized to receive the positioning information of the target WTRU 705.

Alternately, the target WTRU 705 may be configured with a list of client WTRUs information that are authorized to receive positioning information of the Target WTRU 705.

If authorization of the client WTRU 701 fails in step 9, the target WTRU 705 rejects the PC5 connection setup request from the SL Reference WTRU in step 10 and the remaining steps are omitted. Alternately, it may simply ignore the PC5 connection setup request (and the remaining steps shown in FIG. 7 are omitted).

In, on the other hand, the authorization of the SL positioning client WTRU 701 is successful in step 9, then, in step 10, the Target WTRU 705 and the SL reference WTRU(s) 703 instead perform SL positioning operation as requested by the SL positioning client WTRU 701.

Assuming the authorization is successful, in step 10, the Target WTRU 705 and/or SL reference WTRU(s) 703 may communicate with the SL positioning server WTRU or LMF 707 for coordination of SL positioning operation.

If multiple SL reference WTRUs 703 are included in the SL positioning service request in step 7, it is reported to the SL positioning server WTRU or LMF 707 for coordination of SL positioning operation.

Additionally or alternately, if multiple SL reference WTRUs 703 are included in the SL positioning service request in step 6, the request may be delivered to each SL reference WTRU included in the request by the client WTRU or the SL reference WTRU selected in step 5 and, if needed, the Target WTRU and SL reference WTRU(s) may establish PC5 connections with each other.

Additionally or alternately, if multiple SL reference WTRUs are included in the service request in step 7, the SL reference WTRU may forward the SL positioning service request to the Target WTRU and the Target WTRU and SL reference WTRU(s) may establish PC5connections with each other.

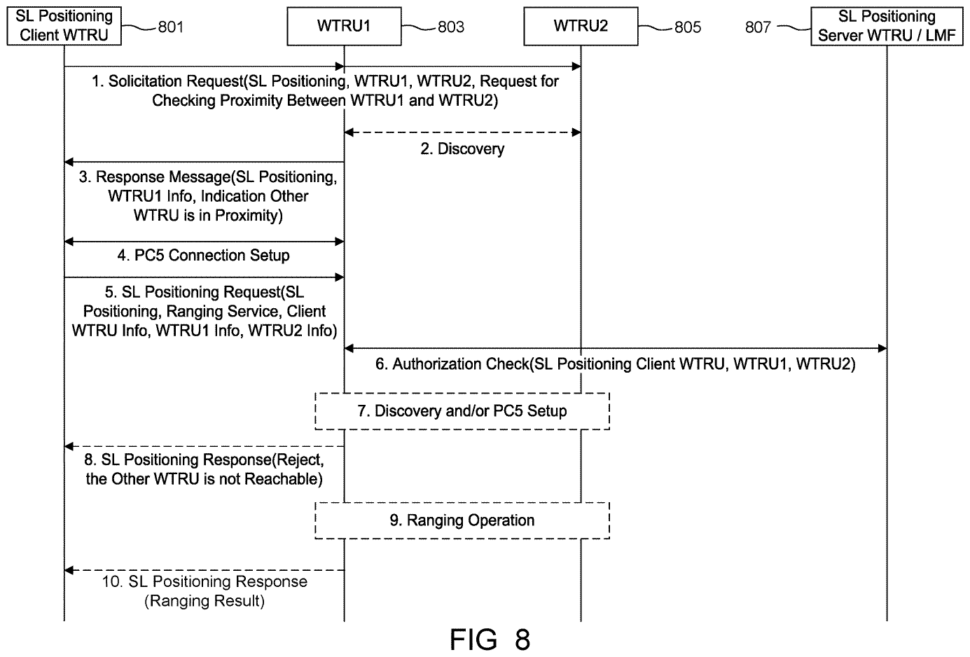

An embodiment may include procedures for ranging with authorization of SL positioning client WTRU(s). FIG. 8 is a signal flow diagram illustrating signal flow for ranging with authorization of the SL positioning client WTRU in accordance with some embodiments.

In step 1, the SL positioning client WTRU 801 is triggered to discover WTRUs (here, WTRU1 803 and WTRU2 805) for ranging between the two WTRUs. The client WTRU 801 sends a Solicitation request message including indication of SL positioning service and info for WTRU1 and WTRU2. The solicitation request may include indication of a request for checking proximity between the two WTRUs.

In step 2, when WTRU1 803 and/or WTRU2 805 receive the solicitation request message from the client WTRU 801, they may respond to the client WTRU. If the solicitation request included a request for checking proximity between the two WTRUs, a WTRU that received the request (here, WTRU1 for sake of example) may check whether the other WTRU 805 is in proximity, for example, by performing a discovery procedure.

Alternately, even though a request for checking proximity between the two WTRUs is not included in the solicitation request message, the WTRU may try to discover the other WTRU included in the solicitation request message.

In step 3, the WTRU (here, WTRU1 803) that received the solicitation request from the client WTRU 801 sends a Response message. The WTRU 803 may include in the response an indication of whether or not the other WTRU is in proximity of it.

In step 4, the Client WTRU 801 may setup a PC5 connection with the responding WTRU (here, WTRU1 803) after a successful discovery procedure. If, on the other hand, the client WTRU 801 receives an indication saying that the other WTRU 805 is not in proximity or WTRU 803 in step 3, the client WTRU 801 may repeat the discovery procedure until it receives an indication saying that both WTRUs are in proximity.

In step 5, the Client WTRU 801 may invoke an SL positioning service request for ranging including information (e.g., user information) of WTRU1 803, information (e.g., user information) of WTRU2 805, and/or information (e.g., user information) of the client WTRU 801.

In step 6, when a SL positioning service request is received, the WTRU (here, WTRU1803) may communicate with the SL positioning server WTRU or 5GC 807 to evaluate whether the SL positioning client WTRU 801 is authorized to receive the ranging and/or positioning information of the WTRU 803. The WTRU1 803 may include user information of the other WTRU (here, WTRU2 805) in the service request for authorization to the SL positioning server WTRU or 5GC 807.

Alternately, the WTRU (here, WTRU1 803) may be configured with a list of client WTRUs information that are authorized to receive ranging and/or positioning information of the WTRU 803.

If authorization of the client UE fails in step 6, the WTRU1 rejects the SL Positioning Request from client WTRU 801 (e.g., in step 8) and the remaining steps in FIG. 8 (including step 7) are not performed. The SL Positioning Response message in step 8 may include a reject code indicating that authorization failed and may also include an indication of the reason why.

If the authorization of the SL positioning client WTRU is successful, then, in step 7, before performing ranging operations, the WTRU (here, WTRU1 803) may perform discovery of the other WTRU (here, WTRU2 805) and a PC5 connection setup procedure with the other WTRU (here, WTRU2 805).

In step 8, when the other WTRU (here, WTRU2 805) is not discovered or the WTRU (here, WTRU1 803) cannot setup a PC5 connection with the other WTRU (here, WTRU2 805), the WTRU 803 may report to the client WTRU 801 by sending a SL positioning response message with reject. The SL positioning reject may include a reject code such as the other WTRU is not reachable.

If, on the other hand, a PC5 connection is successfully established with the other WTRU 805 in step 7, then, instead of performing step 8, steps 9 and 10 are performed. Particularly, in step 9, after a successful PC5 connection setup between the two WTRUs (WTRU1 803 and WTRU2 805), a ranging operation between the two WTRUs may be performed.

In step 10, after the ranging operation, the WTRU (here, WTRU1 801) may report the ranging result to the client WTRU 801.

In step 9, the information of service request including information of WTRU1 and WTRU2 may be reported to the SL positioning server WTRU or LMF 807 for coordination of SL positioning operation and the ranging operation between the two WTRUs may be coordinated by the SL positioning server WTRU or LMF 807.

Additionally or alternately, the SL positioning service request received in step 5 may be also delivered to the other WTRU (here, WTRU2) by the WTRU (here, WTRU1 803).

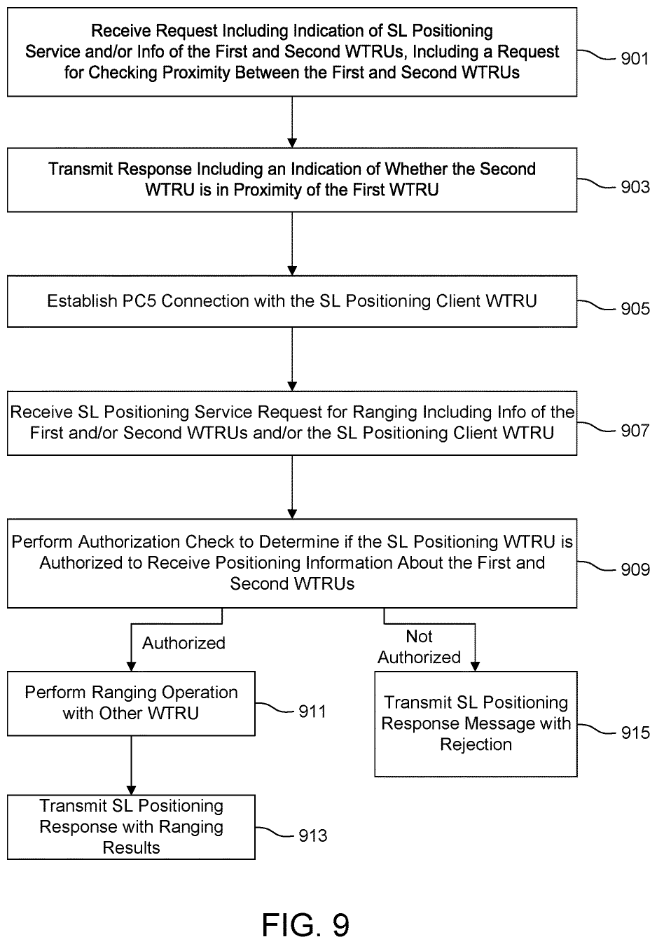

FIG. 9 is a flowchart illustrating one example process for ranging with authorization of the SL positioning client WTRU, e.g., as seen from the perspective of one of the target WTRUs for performing the ranging operation.

In step 901, a first WTRU receives, from an SL positioning client WTRU, a Solicitation Request including indication of SL positioning service and info of the first WTRU and a second WTRU, the Solicitation Request including a request for checking proximity between the first and second WTRUs (such as illustrated in step 1 of FIG. 8).

In step 903, the first WTRU sends a response message to the SL Positioning client WTRU, including an indication of whether the second WTRU is in proximity of the first WTRU.

If so, in step 905, the first WTRU establishes a PC5 connection with the SL positioning client WTRU.

Next, in step 907, the first WTRU receives, from the SL positioning client WTRU, an SL positioning service request for ranging including user info of the first and second WTRUs, and the SL positioning client WTRU.

In step 909, the first WTRU performs an Authorization Check with the network's SL Positioning Server WTRU or its LMF seeking to determine if the SL Positioning WTRU is authorized to receive positioning information about the first and second WTRUs.

If the SL Positioning Client WTRU is authorized to receive positioning information of the first and second WTRUs, then flow proceeds to step 911, in which the first WTRU performs a ranging operation with the second WTRU. Then, in step 913, the first WTRU transmits a SL positioning response message to the SL positioning client WTRU with the range results.

If, on the other hand, the SL Positioning Client WTRU is not authorized to receive positioning information of the first and second WTRUs, then flow proceeds from step 909 to step 915, in which the first WTRU transmits an SL positioning response message to the SL positioning client WTRU with reject.

In an embodiment, the process further comprises performing a discovery process with the second WTRU.

In an embodiment, the process further comprises performing a PC5 setup with the second WTRU.

Another embodiment may include a process for ranging, which may be implemented by a first WTRU. The process may include the first WTRU receiving first information indicating a request to check proximity between the first WTRU and a second WTRU. In one example, the first information may include an indication of a sidelink (SL) positioning service and information associated with any of the first WTRU and/or the second WTRU. The process may also include transmitting second information comprising an indication of whether the second WTRU is in proximity of the first WTRU. On condition that the second WTRU is in proximity of the first WTRU, the process may include receiving, from a third WTRU (e.g., a SL positioning client WTRU), third information indicating a SL positioning service request for ranging. For example, the third information may include information associated with any of the first WTRU, the second WTRU, and/or the third WTRU. In one example, the process may include performing an authorization check to determine whether the third WTRU is authorized to receive positioning information associated with the first and second WTRUs.

In one example, performing the authorization check may include sending a message, to the second WTRU or another WTRU, to determine whether the third WTRU is authorized to receive the positioning information (e.g., as show in step 8 of FIG. 7 or steps 901 and 903 discussed above). For example, the message may include at least the information associated with the third WTRU. In an embodiment, the message may be sent over a PC5 connection established with the second WTRU.

On condition that the third WTRU is authorized to receive the positioning information associated with the first and second WTRUs, the process may include performing a ranging operation with the second WTRU and transmitting a SL positioning response message, to the third WTRU, indicating results of the ranging operation. However, on condition that the third WTRU is not authorized to receive the positioning information of the first and second WTRUs, the process may include transmitting a reject response message to the third WTRU.

In some examples, the process may include the first WTRU performing a discovery process with the second WTRU, and/or establishing a PC5 connection with the second WTRU. In an example, the process may include establishing a PC5 connection with the third WTRU. In some examples, the authorization check may be performed via a SL positioning server or location management function (LMF), or the like.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed”, “computer executed” or “CPU executed”.

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms ““refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms ”does not interface” (and/or the like) may be interpreted as “may not interface” and/or “might not interface”, the terms “does not transmit” (and/or the like) may be interpreted as “may not transmit” and/or “might not transmit”, the terms ”does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean ”at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

[1] TS 23.501v18.1.0: System architecture for the 5G System (5GS)
[2] TS 23.502v18.1.0: Procedures for the 5G System (5GS)
[3] TS 23.273v18.1.0: 5G system (5GS) Location Services (LCS); Stage 2
[4] TS 38.305v17.4.0: NG Radio Access Network (NG-RAN); Stage 2 functional specification of User Equipment (UE) positioning in NG-RAN
[5] TS 37.355v17.4.0: LTE Positioning Protocol (LPP)
[6] TS 23.304v18.1.0: Proximity based Services (ProSe) in the 5G System (5GS)
[7] TS 23.586v0.2.0: Architectural Enhancements to support Ranging based services and Sidelink Positioning
[8] TR 23.700-86 v18.0.0: Study on Architecture Enhancement to support Ranging based services and sidelink positioning

1. A first wireless transmit/receive unit (WTRU), comprising:
circuitry including any of a processor, memory, transmitter and receiver, the circuitry configured to
receive first information indicating a request to check proximity between the first WTRU and a second WTRU, the first information comprising an indication of a sidelink (SL) positioning service and information associated with the first WTRU and the second WTRU;
determine that the first WTRU is in proximity of the second WTRU;
transmit second information comprising an indication that the first WTRU is in proximity of the second WTRU;
establish a PC5 connection with a SL positioning client WTRU that issued the request;
receive, from the SL positioning client WTRU, third information indicating a SL positioning service request for ranging, wherein the third information comprises information associated with the first WTRU, information associated with the second WTRU, and information associated with the third WTRU; and
determine, based on an authorization check, that the SL positioning client WTRU is authorized to receive positioning information associated with the first and second WTRUs; and
perform a ranging operation with the second WTRU; and
transmit a SL positioning response message, to the SL positioning client WTRU, indicating results of the ranging operation.

2. The WTRU of claim 1, the circuitry configured to:
perform a discovery process with the second WTRU.

3. The WTRU of claim 1, the circuitry configured to:
establish a PC5 connection with the second WTRU.

4. (canceled)

5. The WTRU of claim 1, wherein the authorization check is performed via or with a SL positioning server.

6. The WTRU of claim 1, wherein the authorization check is performed via or with a location management function (LMF).

7. The WTRU of any of claim 1, wherein, to perform the authorization check, the circuitry is configured to send a message, to the second WTRU, to determine whether the SL positioning client WTRU WTRU is authorized to receive the positioning information, wherein the message comprises at least the information associated with the SL positioning client WTRU.

8. A method, implemented by a first wireless transmit/receive unit (WTRU), the method comprising:
receiving first information indicating a request to check proximity between the first WTRU and a second WTRU, the first information comprising an indication of a sidelink (SL) positioning service and information associated with the first WTRU and the second WTRU;
determining that the first WTRU is in proximity of the second WTRU;
transmitting second information comprising an indication that the first WTRU is in proximity of the second WTRU; on
establishing a PC5 connection with a SL positioning client WTRU that issued the request;
receiving, from the SL positioning client WTRU, third information indicating a SL positioning service request for ranging, wherein the third information comprises information associated with the first WTRU, information associated with the second WTRU, and information associated with the third WTRU;
determining, based on an authorization check, that the SL positioning client WTRU is authorized to receive positioning information associated with the first and second WTRUs; and
performing a ranging operation with the second WTRU; and
transmitting a SL positioning response message, to the SL positioning client WTRU, indicating results of the ranging operation.

9. The method of claim 8, comprising:
performing a discovery process with the second WTRU.

10. The method of claim 8, comprising:
establishing a PC5 connection with the second WTRU.

11. (canceled)

12. The method of claim 8, wherein the authorization check is performed via or with a SL positioning server.

13. The method of claim 8, wherein the authorization check is performed via or with a location management function (LMF).

14. The method of claim 8, wherein the authorization check comprises sending a message, to the second WTRU, to determine whether the SL positioning client WTRU is authorized to receive the positioning information, wherein the message comprises at least the information associated with the SL positioning client WTRU.

15. (canceled)

16. (canceled)

17. (canceled)

18. (canceled)

19. (canceled)

20. (canceled)

21. (canceled)
